(19) United States
(12) Patent Application Publication
(10) Pub. No.: US 2025/0284860 A1
(43) Pub. Date: Sep. 11, 2025

(54) Accelerated Design Process for Traction Electric Motors

(71) Applicant: Vitesco Technologies USA, LLC, Auburn Hills, MI (US)

(72) Inventors: Mohammad Hossain Mohammadi, Windsor (CA); Andrei-Radu Negrila, Sag (RO)

(73) Assignee: Vitesco Technologies USA, LLC, Auburn Hills, MI (US)

(21) Appl. No.: 19/072,457

(22) Filed: Mar. 6, 2025

Related U.S. Application Data
(60) Provisional application No. 63/562,104, filed on Mar. 6, 2024.

(51) Int. Cl. G06F 30/20; G06F 30/12; G06F 111/08

(52) U.S. Cl. CPC G06F 30/20; G06F 30/12; G06F 2111/08

(57) ABSTRACT

A method for optimizing a design of an electric motor is disclosed. The method includes receiving, at a hardware computing device, user parameters from a user interface in communication with the hardware computing device. The user parameters include one or more traction electric motor design limitations. The method also includes determining, at the hardware computing device, a problem specification based on the user parameters, and executing, at the hardware computing device, a global design search of traction electric motor designs based on the problem specification within a global design region. The method also includes identifying, at the hardware computing device, a high-performing design region being a portion of the global design region, where the high-performing design region includes multiple motor designs.

### CROSS REFERENCE TO RELATED APPLICATIONS

This U.S. patent application claims priority under 35 U.S.C. § 119(e) to U.S. Provisional Application 63/562, 104, filed on Mar. 6, 2024, which is hereby incorporated by reference in its entirety.

### TECHNICAL FIELD

The disclosure relates to an accelerated design process for traction electric motors.

### BACKGROUND

In the past few years, the automotive industry has undergone a major transformation as electric vehicles (EVs) gain traction in the global market. EV sales in the United States have hit record highs, due to a multitude of reasons, including, but not limited to, government policies, infrastructure growth, a shift in consumer preference due to environmental concerns, and the improvement in EV performance.

Traction motors are a specific type of motors used in electric vehicles and provide high torque at low speeds, which is essential for moving and accelerating the vehicle from a stop. In addition, traction motors produce high output power at high speeds to enable highway driving. Traction electric motors, such as axial flux permanent magnet synchronous motors (AFPSMs), are challenging to design due to their geometric complexity and longer simulation times than radial flux motors. In some examples, AFPSMs require a three-dimensional (3D) simulation environment which is exponentially slower than running a two-dimensional (2D) simulation. These traction electric motors do not have explicit mathematical functions of their performance metrics relating to their geometric parameters. This forces motor designers to rely on accurate yet computationally expensive physics-based simulation models, such as, but not limited to finite element analysis (FEA), for numerically solving Maxwell's equations of electromagnetism. Therefore, several methods are known that overcome the complexity of designing an axial flux motor and related motor topologies.

A known method for the electromagnetic design of a wound-field synchronous generator (radial flux) describes the use of DQ flux linkage modeling. This method describes a three-stage generator exciter electromagnetic structure. Another known design describes a modeling method that uses a magnetic equivalent circuit for designing an axial flux switching motor with hybrid excitation. Yet another motor design method and optimization for a yokeless axial flux motor uses a magnetic equivalent circuit model. It is also known to have a design optimization of a double stator single rotor axial permanent magnet motor using magnetic circuit modeling. Another known example provides a permanent magnet-armature double-harmonic collaborative optimization design method for a magnetic field-modulated permanent magnet motor for electric automobiles, wind power generation. In another known example, a multi-objective optimization method to reduce the material cost of ferrite-assisted synchronous reluctance motors using statistical analysis is described. Another known numerical methodology reduces the number of computations required to optimally design the rotors of synchronous reluctance machines (SynRMs) with multiple barriers. The design methodology considers two objectives, average torque and torque ripple, which have been simulated for thousands of SynRM models using 2D finite element analysis. The use of a two-level surrogate-assisted optimization algorithm is also known for electric machine design using 3-D FEA. The algorithm achieves the optima with much fewer

FEA evaluations than conventional methods. An analytical optimal design tool is also known and determines a megawatt-scale yokeless and segmented armature (YASA) machine design that fulfills application requirements and constraints. This analytical tool considers both electromagnetic and structural designs.

As described above, several methods for designing an axial flux machine and related motor topologies are known, but there is a need for an improved method that is efficient and saves cost by reducing development and/or engineering time.

### SUMMARY

One aspect of the disclosure provides method for optimizing a design of an electric motor. The method includes receiving, at a hardware computing device, user parameters from a user interface in communication with the hardware computing device. The user parameters include one or more traction electric motor design limitations. The method also includes determining, at the hardware computing device, a problem specification based on the user parameters, and executing, at the hardware computing device, a global design search of traction electric motor designs based on the problem specification within a global design region. The method also includes identifying, at the hardware computing device, a high-performing design region being a portion of the global design region, wherein the high-performing design region includes multiple motor designs.

Implementations of the disclosure may include one or more of the following optional features. In some implementations, the method further includes executing a higher resolution simulation of the high-performing design region and determining an optimized design within the high-performing design region. The optimized design is based on the user parameters and desired operating points. In some examples, the problem specification includes parameters that in turn include desired target performance parameters, technical target parameters, desired operating points.

In some implementations, prior to executing a global design search, the method includes determining the optimal motor design based on stored design parameters, when it is determined that design parameters similar to the parameters of the problem specification are stored in hardware memory.

In some examples, the method includes generating design samples based on the problem specification using Design of Experiment (DoE) method and computing simulation-based parametric models of traction electric motor, where each model is indicative of a different motor design. The method may also include performing first statistical analysis (such as, but not limited to, correlation analysis); determining a statistical coefficient based on the first statistical analysis; and reducing a number of design parameters based on the statistical coefficient. The method further includes determining infeasible geometric motor designs from the computed simulation-based parametric models of the traction electric motor using the reduced number of design parameters; and for the feasible geometric motor designs, determining a representative reduced-order dq model of each design sample and determining control strategies of the design samples. In some examples, the method also includes determining one or more Key Performance Indicators (KPIs) for each one of the geometric motor designs; determining additional infeasible design samples based on the determined one or more KPIs; and executing a second statistical analysis causing a reduction of the feasible geometric motor designs. The one or more KPIs may include, but are not limited to peak power, peak torque, maximum speed power, peak power density, peak torque density, peak current density, specific power, specific torque, airgap shear stress, power factor, constant-torque base speed, constant-power base speed, saliency ratio, per-unit magnet flux linkage, characteristic current, short-circuit current, DC winding resistive losses at different operating conditions, magnetic flux densities in different parts, volumes of different parts, masses of different parts, total material cost, material costs of different parts, material price per power, material price per torque, global warming potential, optimal current amplitudes, phase advance angles and stator phase voltages for different operating points, average torque, torque ripple, power factor, winding AC losses, core losses, magnet losses, efficiency, demagnetization risk, total harmonic distortion of the stator voltages and currents, phase RMS voltages and currents.

Another aspect of the disclosure provides a method for optimizing a design of an electric motor. The method includes executing three stages. During the first stage: the method includes executing, at a hardware computing device, a global design search for a wide design space of traction electric motor designs; and removing, at the hardware computing device, non-optimal design regions using coarse and cheap simulation models. During the second stage, the method includes evaluating, at the hardware computing device, key performance indicators (KPIs) of the traction electric motor designs within a remaining design region; and identifying, at the hardware computing device, high-performing design regions of traction electric motor designs via statistical analysis based on the KPIs. During the third stage, the method includes determining, at the hardware computing device, a reduced design space for a local design region of traction electric motor designs to employ a higher resolution of design points using the same coarse simulation model or a finer simulation model; and determining, at the hardware computing device, an optimized design of the traction electric motor from the reduced design space.

Implementations of this aspect of the disclosure may include one or more of the following optional features. In some implementations, during the second stage, the method further includes determining infeasible design samples based on the determined one or more KPIs; and executing statistical analysis causing a reduction of the feasible geometric motor designs. The statistical analysis may include a sensitivity analysis.

In some examples, before executing the first stage, the method includes receiving user parameters from a user interface in communication with the hardware computing device, and determining, at the hardware computing device, a problem specification based on the user parameters. The user parameters may include one or more traction electric motor design limitations.

In some examples, the method also include determining when design parameters similar to the parameters of the problem specification are stored in hardware memory before executing the first stage. When it is determined that design parameters similar to the parameters of the problem specification are stored in hardware memory, the method includes determining the optimal motor design based on a stored design.

The problem specification includes parameters that in turn include initial design parameters, desired target performance parameters, technical target parameters, and desired operating points.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1A is a schematic view of an exemplary design optimization system.

FIGS. 1B, 1C, and 1D are schematic views of exemplary design regions determined by the optimization system of FIG. 1A.

FIG. 2A is schematic view of an exemplary optimization process executed by the design optimization system of FIG. 1A.

FIGS. 2B and 2C are schematic views of exemplary torque-speed and power-speed planes.

FIG. 3A is a schematic view of an exemplary first stage of the optimization process shown in FIG. 2A.

FIG. 3B is a schematic view of an exemplary nonlinear direct-quadrature current plane.

FIG. 3C is a schematic view of exemplary optimal control trajectories for different performance curves as functions of the motor speed.

FIG. 4 is a schematic view an exemplary second stage of the exemplary optimization process shown in FIG. 2A.

FIG. 5 is a schematic view an exemplary third stage of the exemplary optimization process shown in FIG. 2A.

Like reference symbols in the various drawings indicate like elements.

### DETAILED DESCRIPTION

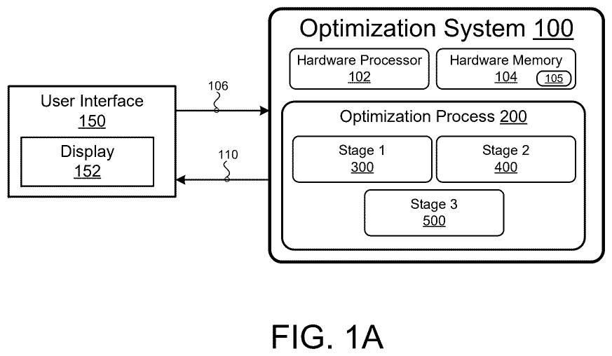

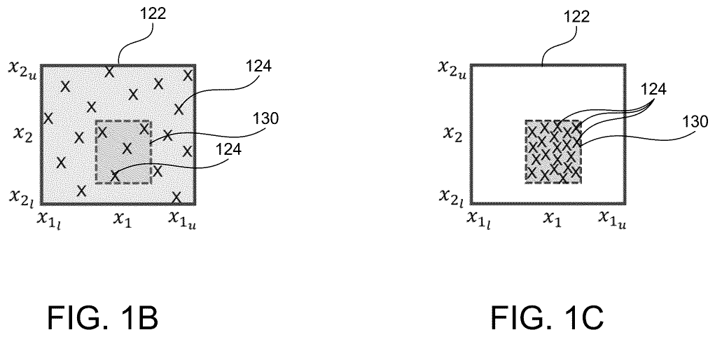

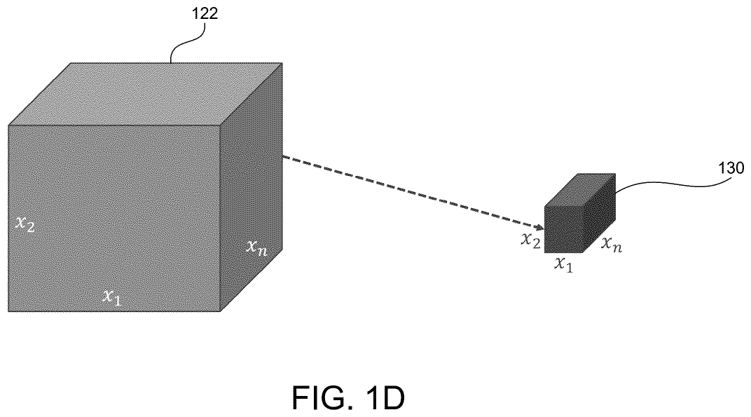

FIG. 1 shows a design optimization system 100 that executes a multi-stage process 200 for optimizing the design of traction electric motors. The multi-stage design process 200 is configured to optimize the design of different classes of traction electric motors, including but not limited to, axial flux permanent magnet synchronous motors (AFPSMs) as well as radial flux topologies such as permanent magnet synchronous motors (PSMs), permanent magnet-assisted synchronous reluctance motors (PMa SynRMs), interior permanent magnet synchronous motors (IPMSMs), and synchronous reluctance motors (SynRMs). As shown, the design optimization system 100 includes a hardware processor (i.e., hardware computing device) 102 (e.g., central processing unit having one or more computing processors) in communication with non-transitory memory 104 (e.g., hardware memory, a hard disk, flash memory, random-access memory) capable of storing instructions executable on the computing processor(s) 104. The hardware processor 102 executes the optimization process 200 causing the optimization system 100 to output an optimal motor design 110 based on one or more received user parameters 106. In some examples, the hardware device 102 and/or the memory 104 are a separate system in communication with the processing device 100 via a network. The remote system may be a distributed system (e.g., a cloud environment) having scalable/elastic computing resources and/or storage resources. The network may include various types of networks, such as a local area network (LAN), a wide area network (WAN), and/or the Internet. In some examples, the optimization process 200 is executed using a neural network (NN) which is a computational approach used in computer science, among other disciplines, and is based on a large collection of neural units, loosely imitating the way a biological brain solves problems with large clusters of biological neurons connected by axons. The neural network is self-learning and trained, rather than programmed, and excels in areas where the solution feature detection is difficult to express in a traditional computer program.

In some implementations, the optimization process 200 is a multi-stage process and includes three stages: a first stage 300, a second stage 400, and a third stage 500. The three stages 300, 400, 500 effectively use an allocated computational budget in a relevant design region rather than waste computational resources unnecessarily. The optimization process 200 is configured to generate hundreds or thousands of traction electric motor designs 124 in significantly less time than typical design approaches by executing the optimization process 200. In addition, the optimization process 200 provides rapid development of new designs of traction electric motors for different applications, incorporates physical targets and constraints of traction electric motors, and reduces engineering man-hours by automating the design process.

Referring to FIGS. 1B and 1C, during the first stage 300, the design optimization system 100 executes a global design search to explore and evaluate a wide design space 122 of traction electric motor designs 124 to eliminate non-optimal design regions using computationally coarse and cheap simulation models (e.g., magnetostatic analysis and/or lumped parameter models). As shown, the wide design space 122 is in a two-dimensional view for simplicity but may be n-dimensional as shown in FIG. 1D depending on the number of design parameters. During the second stage 400, the design optimization system 100 quickly evaluates the key performance indicators (KPIs) and then identifies a high-performing design region 130 of traction electric motor designs 124 via statistical analysis as shown in the figures. In some examples, the design optimization system 100 identifies more than one high-performing design regions 130. Finally, during the third stage 500, the design optimization system 100 reduces the design space for a local design region 130 of traction electric motors to employ a higher resolution of design points using a computationally finer simulation model (e.g., magnetotransient). In other words, during the first stage 300, the design optimization system 100 determines the first wide design space 122 that includes several electric motor designs 124. Following, during the second stage 400, the design optimization system 100 identifies a high-performing design region 130. Finally, during the third stage 500, the design optimization system 100 executes a more detailed analysis of the one or more design points 124 within the high-performing design region 130. As used, the design spaces 122, 130 are mathematical spaces representing ranges of possible variations for design parameters for which different geometric designs 124 of traction electric motors are possible.

With continued reference to FIG. 1A, the design optimization system 100 is in communication with a user interface 150 having a display 152. The user interface 150 is configured to communicate with the design optimization system 100 by allowing an end user to enter one or more parameters and commands via the user interface 150 that are communicated to the design optimized system 100. The user interface 150 may include, but is not limited to, a mobile computing device, such as a desktop computer, a laptop, a tablet, and a smart phone. The computing device may use any of a variety of different operating systems. The computing device executes a communication application for communication with the optimization system 100. In some examples, the user interface 150 and the optimization system 100 are one device.

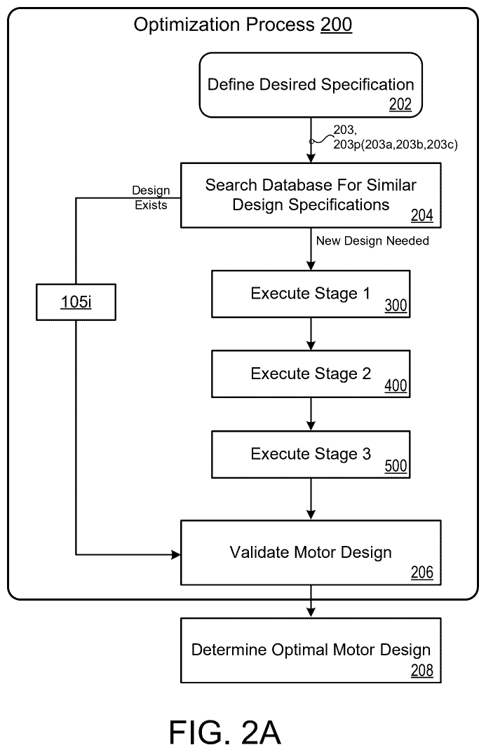

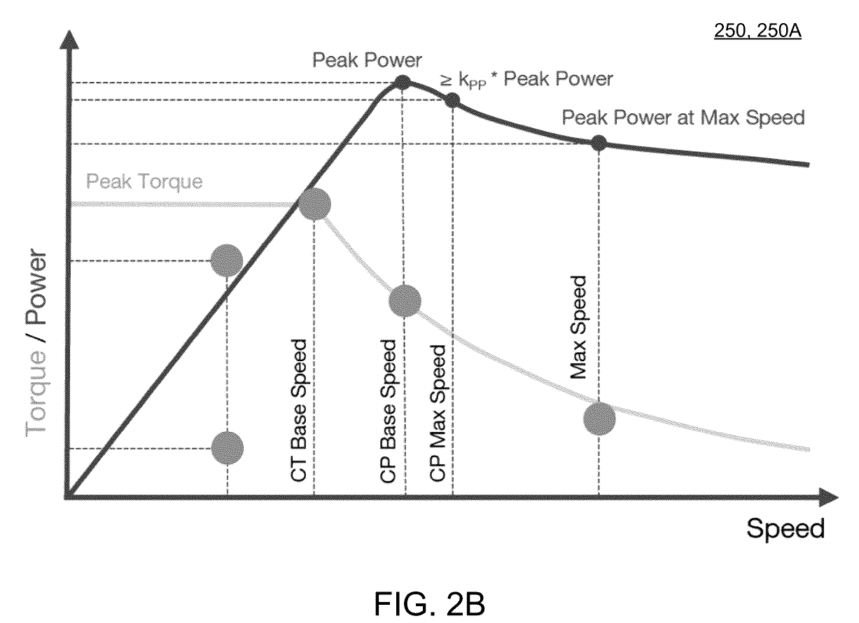

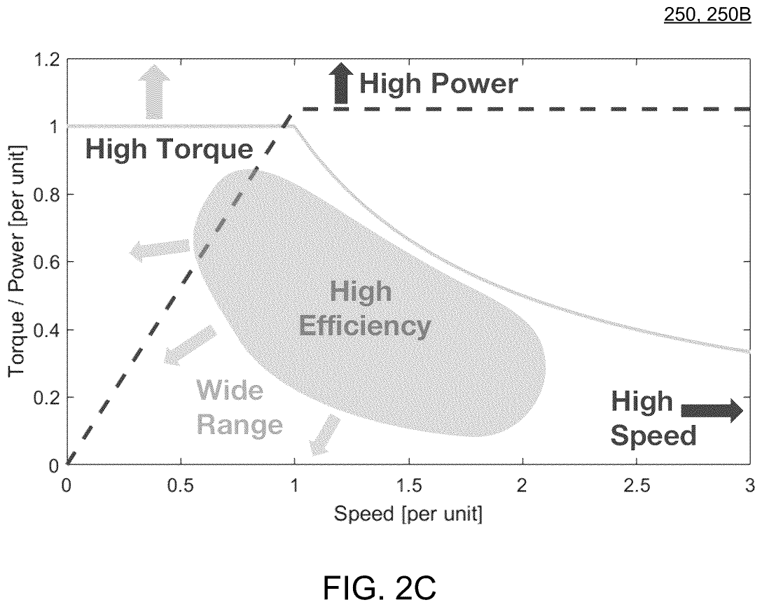

Referring to FIG. 2A, the optimization process 200 starts at block 202 by defining a problem specification 203 based on user parameters 106. The problem specification 203 includes initial design parameters 203p that includes desired target performance parameters 203a (e.g., expected torque and power levels, cooling system, inverter system, packaging constraints), technical target parameters 203b (e.g., power density, peak efficiency, magnet mass, material cost), and desired operating points 203c (e.g., peak torque, maximum speed, partial load). The user parameters 106 may be entered into one or more sheets, where each sheet is divided into rows and column and includes numbers, strings, ranges, etc., that is used by the optimization process 200 to determine the design objectives and constraints required for the optimal motor design 110. Other data entries that include the user parameters 106 may be used. A few of the technical targets 203b are demonstrated in the torque-speed and power-speed planes 250, 250A of FIG. 2B, including but not limited to the peak torque, peak power, peak power at maximum speed, constant-torque base speed, constant-power base speed, constant-power maximum speed, maximum speed, etc. For most applications, the technical targets 203b are optimized to yield the best performance of the traction motor. The desired operating points 203c are overlaid on top of the torque-speed curve of the traction motor to check whether the motor can meet those operating points in later stages of the optimization process 200. If any of the desired operating points 203c is outside the bounds of the torque-speed curve, then the traction motor is considered to be an infeasible design. As shown in the torque-speed and power-speed planes 250B of FIG. 2C, a traction motor must yield high torque, high power, high speed, high efficiency, and a wide range for the high efficiency region. In general, meeting these technical targets 203b is a complex task and requires setting tradeoffs based on the end user's priorities. It is possible that a few of these technical targets 203b are conflicting with each other; such that improving one target results in a diminishing return for another target.

At block 204, the optimization process 200 compares the initial design parameters 203p with prestored design parameters 105 stored in the hardware memory 104. The prestored design parameters 105 are part of pre-existing datasets that were determined prior to the execution of the optimization process 200. The optimization system 100 is configured to refine its datasets every time the optimization process 200 is executed. As such, as more data is generated and collected through the optimization process 200, the set of prestored design parameters 105 grows in size within the hardware memory 104.

If the optimization system 100 determines that similar design parameters 105 are stored in the hardware memory 104, then the optimization system 100 outputs an initial design specification 105i based on the stored design parameters 105. The initial design specification 105i includes a comprehensive list of design parameters for creating and validating a selected traction motor design that meets the initial design parameters 202p that are based on the user parameters 106. This list of design parameters includes one or more motor topologies, the corresponding geometrical dimensions of the various motor parts (e.g., stator core, rotor core, windings, permanent magnets, shaft, housing, cooling), winding pattern/layout, magnetization direction of the permanent magnets, inverter system specifications (e.g., DC link voltage, peak phase current), etc. The motor topologies, may include, but are not limited to, e.g., Axial Flux Permanent Magnet Synchronous Motor (AFPSM), Permanent Magnet Synchronous Motor (PSM), Interior Permanent Magnet Synchronous Motor (IPMSM), Permanent Magnet-Assisted Synchronous Reluctance Motor (PMa SynRM), Synchronous Reluctance Motor (SynRM). All these design parameters yield a feasible traction motor that may be physically constructed and reproduced to match the specification requirements based on the user parameters 106. Additionally, when the initial design specification 105i is determined, then the optimization system 100, at block 206, validates the initial design specification 105i by comparing it with the expected specifications previously determined based on detailed simulation and/or experimental results. Based on the validation, the optimization system 100 determines an optimal motor design 110 at step 208 that is outputted to the user via the user interface 150.

Referring back to block 204, when the optimization system 100 compares the desired parameters 202p with prestored design parameters 105 stored in the hardware memory 104 and does not find a similar design 105, then the first stage 300 is executed.

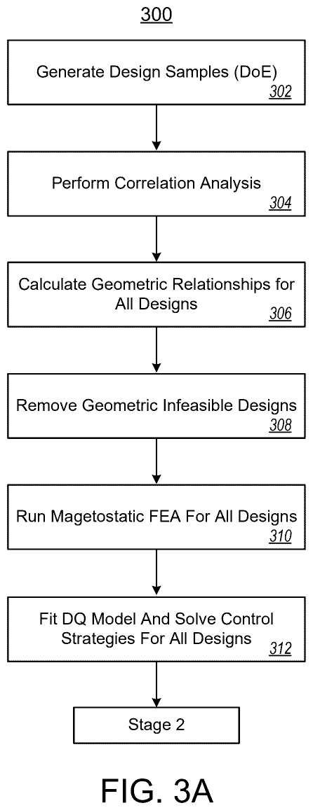

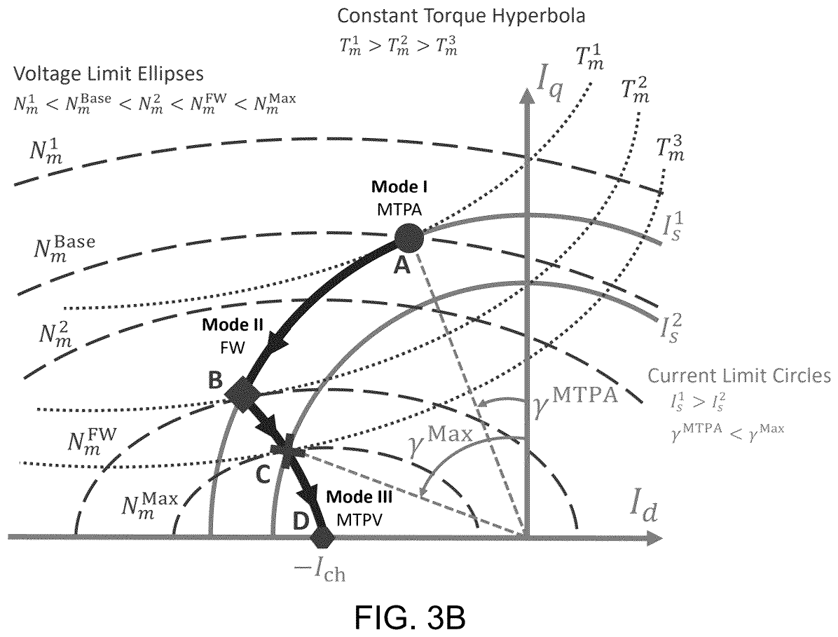

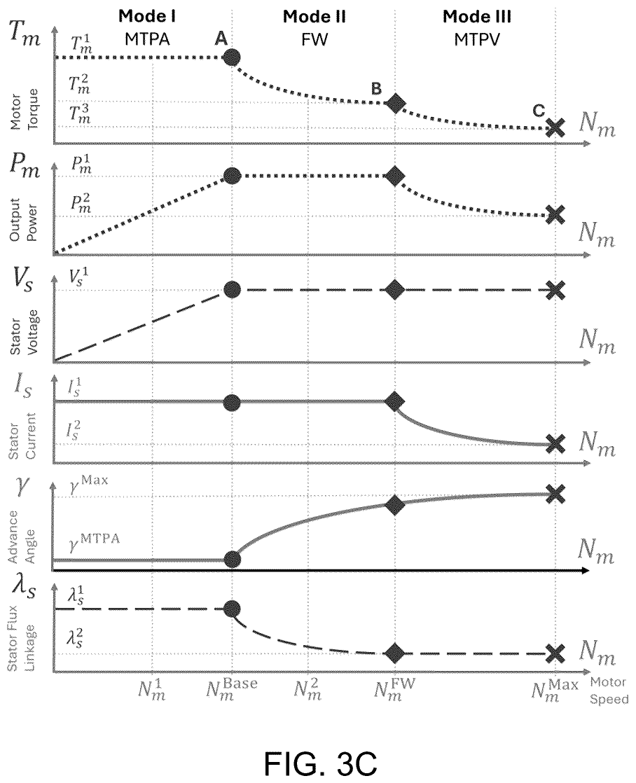

Referring to FIGS. 1B and 3A, the first stage 300 is executed to explore a wide design space 122 of traction electric motors 124 to eliminate non-optimal design regions using coarse and cheap simulation models (e.g., magnetostatic analysis) to quickly evaluate the key performance indicators (KPIs) during the second stage 400. At block, the optimization process 200 generates design samples using a Design of Experiment (DoE). DoE is a method for planning, conducting, analyzing, and interpreting tests. For example, a Latin Hypercube sampling is used to uniformly sample each design parameters over pre-defined ranges. Other methods may also be used. During this step, the optimization process 200 computes a simulation-based parametric model of the traction electric motor, such as a 2D or 3D electromagnetic finite element model with symmetry boundary conditions to speed up the electromagnetic computations while preserving accuracy. Based on the parametric simulation model of the traction electric motor, a DoE is performed (e.g., Latin Hypercube sampling) for all design parameters around a reference design. The lower and upper bounds of each design parameter may be calculated based on percentage variations around a reference design. Otherwise, the lower and upper bounds are inputted directly by the end user based on the desired parameters 202p. The number of design parameters is not limited and can exceed ten in total. Each design sample is defined as a unique traction electric motor with a different variation of design parameters. The different design parameters include, for example, stator outer diameter, stator slot width, stator back-iron thickness, wire dimensions, airgap thickness, rotor outer diameter, flux barrier thicknesses, magnet widths and thickness, shaft diameter, materials used, etc. In other words, this step allows the optimization system 100 to create a representative reduced-order dq model of the traction motor to reduce the simulation time needed. In other words, the optimization system 100 considers the relevant physics of the traction motor and creates an equivalent circuit model based on dq flux linkages, allowing the optimization system 100 to create torque-speed and power-speed curves in significantly less time than using FEA models.

At block 304, the optimization process 200 performs correlation analysis on all the design samples created by the DoE. Correlation analysis calculates the statistical distribution of the design parameters to reduce the number of design parameters by removing the dependent parameters, thus eliminating redundancy of dimensions. The strength of such design parameter-to-parameter relationships is measured via a correlation coefficient, such as the Spearman rho to capture monotonic and nonlinear behaviors. If the correlation coefficient is above +0.5, this relationship is considered to be strong and positive, while below −0.5 signifies strong and negative. The optimization system 100 considers either strong positive or strong negative correlations, and removes one of the two design parameters since they are dependent on each other and are statistically correlated. Weak correlations between −0.1 and +0.1 demonstrate that the design parameters are more or less independent from each other and must be preserved. The values of these thresholds are set based on experience and are application dependent. The correlation analysis in block 304 allows the optimization system 100 to reduce the total number of design parameters in order to speed up the computational efficiency of the optimization process 200, while preserving the statistical independence of the design samples. Any discrete variable, such as the number of coil turns, is rounded to guarantee practical motor constraints. The maximum limit of the stator current magnitude for each design sample is calculated and set based on the stator coil dimensions to guarantee that each design sample has the same current density to preserve the motor's thermal limits.

Following at block 306, the optimization process 200 mathematically calculates the geometry of all the design samples from block 304 to check for any infeasibility. An infeasible design sample is defined as a traction motor geometry that is not practical to create based on the dimensions and tolerances from manufacturing processes. At block 308, the optimization process 200 removes geometrically infeasible designs from the set of sampled designs in order to reduce the computational effort needed to run FEA simulations. Only design samples that are geometrically feasible are preserved.

At block 310, the traction electric motor is simulated using a magnetostatic FEA model for each design sample that was preserved due to its feasibility (block 308). This electromagnetic simulation requires a single time instant to calculate the stator winding phase resistance and stator phase flux linkages for different winding excitation conditions. These include sweeps over the stator current magnitudes and the phase advance angles due to the synchronous nature of the traction electric motor. More time samples in one torque or one electrical period can be included to increase the accuracy of the representative motor model, since the stator phase flux linkages have a slight dependency with the rotor's angular position in the traction motor. At least three current magnitudes are required starting from zero to account for magnetic saturation effects. More intermediate sweeps for the current magnitude can be added for a higher model resolution, especially for partial loading conditions. The phase advance angle is varied from 0 to 90 electrical degrees in the motoring region and from 90 to 180 electrical degrees in the generating region. This sweep over the phase advance angle enables the representative motor model to account for cross-coupling effects in the magnetic circuit. The volumes and masses of all motor components are also calculated from the geometry.

At block 312, for each design sample, the optimization process 200 fits a nonlinear direct-quadrature (dq) model of the traction electric motor using the magnetostatic simulation data and least-squares curve fitting. The dq motor model is a mathematical representation of how the traction electric motor behaves so the motor's behavior can be explained in both time and frequency domains. The optimization process 200 converts the stator phase flux linkages from three phases to the dq reference frame using the Park transformation. The optimization process 200 fits the dq-axis flux linkages to explicit functions of the dq-axis currents. For example, each flux linkage map (d and q) can be a 2^{nd} order polynomial function for two inputs of dq-axis currents with six polynomial coefficients. Other interpolation functions may also be used, such as, but not limited to smoothing spline. The dq motor model is then used to solve control strategies of synchronous AC motors (e.g., Maximum-Torque-Per-Ampere, Flux Weakening, Maximum-Torque-Per-Volt, Maximum-Torque-Per-Watt, etc.) to find the optimal operating points for each design sample in a torque-speed plane 250 shown in FIG. 2B and 2C. All the possible operating points in the torque-speed plane 250 are then computed using the dq motor model and electric drive constraints (e.g., DC link voltage, pulse-width-modulation scheme, maximum phase current).

FIG. 3B shows a dq current plane having two axes, I_{d} and I_{q}. For a given peak phase current amplitude, Iₛ₁, the dq currents form a current limit circle. All dq current points inside and along the current limit circle are feasible values to create torque by the traction electric motor. Depending on the dq flux linkage maps (representative motor model), each torque isoline with constant values is illustrated as a hyperbola denoted as Tₘ₁, Tₘ₂, Tₘ₃, etc. The Maximum-Torque-Per-Ampere (MTPA) control strategy, denoted as Mode I at point A, maximizes the torque produced by the motor for a given phase current amplitude which corresponds with the tangent of the constant torque hyperbola Tₘ₁ with the current limit circle Iₛ₁ at the MTPA advance angle γ^{MTPA}. This MTPA control strategy minimizes the winding resistive loss for a given torque value. As the motor speed Nₘ increases from zero rpm, the voltage limit ellipse shrinks due to the back electromotive force (EMF) induced by the rotor's magnetic field on the stator windings. This reduction in the ellipse's radius reduces the feasible region in the dq current plane. Once the motor's base speed Nₘ^{Base} is reached, the MTPA control strategy is no longer possible due to the smaller set of feasible dq currents and the optimal control trajectory moves along the current limit circle from points A to B through the Flux Weakening (FW) control strategy, denoted as Mode II. Here, the current magnitude does not change but the advance angle γ increases to weaken the rotor flux and enable higher speeds. Upon exceeding the FW speed at point B, Nₘ^{FW} the voltage limit ellipse continues to shrink such that the dq currents along the Iₛ₁ current limit circle are no longer feasible. The Maximum-Torque-Per-Voltage (MTPV) control strategy, denoted by Mode III, then activates from point B such that the torque is maximized for a given stator voltage and/or flux. This means that the current amplitude and the phase advance angle must decrease together to arrive at Iₛ₂ and γ^{FW} until the maximum speed Nₘ^{Max} of the traction motor is reached at point C. This maximum speed is typically set by mechanical constraints due to the centrifugal forces acting on the rotor geometry. If not for the maximum speed constraint, the MTPV control strategy could continue to operate until point D at a theoretical infinite speed (also centerpoint of the voltage limit ellipses) for which the q-axis current is zero and the d-axis current is set to the negative value of the characteristic current. This characteristic current I_{ch} is desired to be as close as possible to the rated current of the traction electric motor to enable optimal FW performance and a wider constant-power region. FIG. 3C demonstrates similar points of the optimal control trajectory for different performance curves as functions of the motor speed Nₘ, including the motor torque Tₘ, output power Pₘ, stator phase voltage Vₛ, stator phase current Iₛ, phase advance angle γ, and stator flux linkage λₛ. Hence, the motor control strategies described above are solved for all design samples using their dq models. Therefore, the output of the first stage 300 is a representative reduced-order dq model of each design sample to simplify the calculations made in the following stage (i.e., the second stage 400). With the help of the dq motor model, important KPIs of the design samples can be computed during the second stage 400 and perform the subsequent steps.

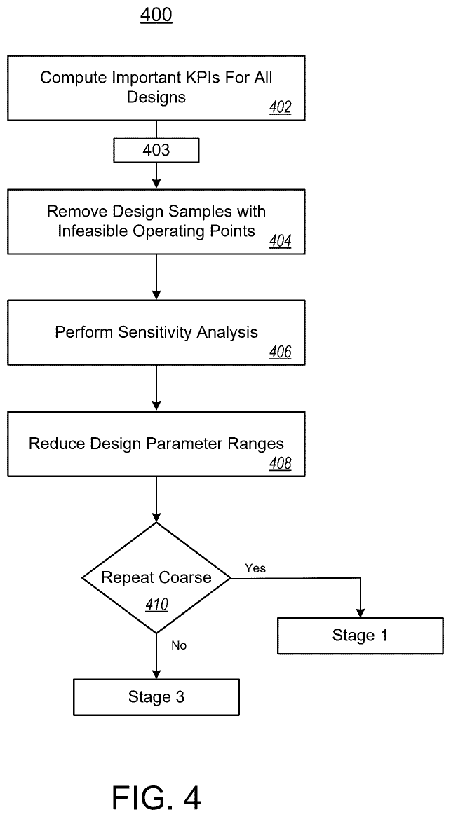

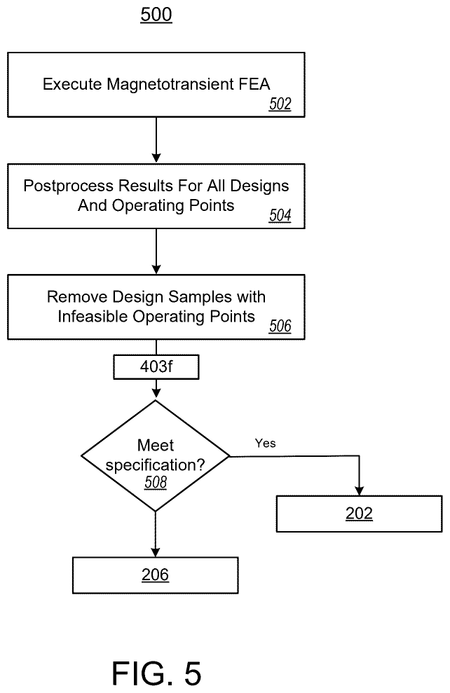

Referring back to FIG. 2A and FIG. 4, following the first stage 300, the second stage 400 is executed. During the second stage 400, the optimization process 200 identifies high-performing design regions 130 of traction electric motors via statistical analysis by analyzing all the magnetostatic results.

At block 402, the optimization process 200 computes important KPIs of the feasible design samples using the performance curves calculated via the dq motor models. The important KPIs include, but are not limited to, peak power, peak torque, maximum speed power, peak power density, peak torque density, specific power, specific torque, base speed, saliency ratio, per-unit magnet flux linkage, characteristic current, DC winding resistive losses at different operating conditions, volumes of different parts, masses of different parts, material cost, material price per power, material price per torque, global warming potential, optimal current amplitudes, phase advance angles and stator phase voltages for selected operating points, Boolean flags for the desired operating points 106c, demagnetization risks of permanent magnets, etc. The KPIs are arranges in a KPI results table 403 where each row of the KPI results table 403 correspond to each design sample, while each volume is a computed KPI mentioned above. The desired operating points 203c are then checked against the torque-speed plane 250 for each design sample 124.

At block 404, when the desired operating points 106c cannot be reached in the torque-speed plane 250, then the optimization process 200 determines that the motor design sample 124 is infeasible and the optimization process 200 flags the motor design sample 124 in the KPI results table 403. By removing these infeasible designs from the consideration process, the optimization process 200 ensures that “bad designs” are not simulated unnecessarily in the next stages of the design process, thus reducing the overall computational effort of the optimization process 200. The feasible designs that meet all the desired operating points 106c are kept and passed onto the next step.

Following, at block 406, the optimization process 200 executes a sensitivity analysis to determine relationships of the performance metrics as it relates to the design parameters. The strength of such performance-parameter relationships is measured via a correlation coefficient, such as the Spearman rho to capture monotonic and nonlinear behaviors. If the correlation coefficient is above +0.5, this relationship is considered to be strong and positive, while below −0.5 signifies strong and negative. Weak correlations between −0.1 and +0.1 demonstrate that the design parameters do not influence the performance metrics. A strong correlation means that a change in a design parameter heavily influences the value of performance metric. The values of these thresholds are set based on experience and are application dependent.

At block 408, the optimization process 200 reduces the parameter ranges in the design optimization problem based on the sensitivity analysis and the feasible design points that guarantee the desired operating points 106c. For each design parameter, the feasible design range is computed to exclude infeasible design regions; for example, a very small stator outer diameter may not yield feasible designs and its corresponding lower bound must be increased. These feasible parameter ranges are then combined to resample the design space 130 of the traction electric motor to again explore a smaller region with more density of points. It is expected that the reduction of this design space can be as significant as 50-80% compared to the initial design space, thereby enabling a more efficient use of computational resources while arriving rapidly at optimal designs for an application.

At block 410, based on the statistical results in of block 408, there are two options to follow. The first option, the optimization process 200 resample a smaller design region with a higher density of design points and repeats the magnetostatic simulations as in Stage 1 in this restricted region. The second option, the optimization process 200 proceed to the third stage 500 to perform a local design search if a smaller design region can no longer be identified and the existing ranges of design parameters are satisfactory.

The third stage 500 begins, at block 502 with the optimization process 200 selecting the best motor designs from the restricted set of design samples and calculating the detailed performances using magnetotransient FEA simulations. The selection of the optimal designs is based on the requirements set in the problem specifications that are based on the user parameters 106 since each application has a different set of criteria and priorities. For each design sample based on the output of the second stage 400, the optimization process 200 computes the magnetotransient results as functions of time, including but not limited to, the instantaneous electromagnetic torque, winding AC loss, stator and rotor core losses, magnet eddy current loss, stator phase voltages, stator phase flux linkages, stator phase current, etc.

At block 504, the optimization process 200 postprocesses the magnetotransient KPIs for each restricted design sample, including but not limited to, the average torque, torque ripple, power factor, winding AC losses, core losses, magnet losses, efficiency, demagnetization risk, total harmonic distortion of the stator voltages and currents, phase RMS voltages and currents, etc. Following, the optimization process 200 adds these magnetotransient KPIs to the KPI results table 403 as additional columns. When the desired operating points 106c cannot be reached in the torque-speed plane 250 based on the newly computed magnetotransient KPIs, the optimization process 200 determines that the restricted design sample 124 is infeasible and the optimization process 200 flags the motor design sample 124 in the KPI results table 403.

At block 506, the optimization process 200 removes these infeasible designs from the consideration process to ensure that only feasible design samples are sustained in the design process. The feasible designs that meet all the desired operating points 106c are kept and passed onto the next step.

At block 508, the combined magnetostatic and magnetotransient results in the KPI results table 403f of the restricted design samples 124 are compared against each other to select one or more optimal motor designs 124 for an application. For example, the magnet mass is often desired to be reduced to minimize the material cost and the global warming potential of a traction electric motor; this KPI can be weighed higher than other metrics such as the specific torque and/or power density. A multi-objective optimization function is then set to place more weight on important KPIs that are of higher interest (e.g. active material cost, peak power density, magnet mass), while setting multiple constraints on the other design parameters and performance metrics based on the desired operating points 106c. For example, the peak torque must always be higher than or the same as the desired value set by the end user. If the results are not satisfactory, the multi-stage design process restarts before the first stage 300 using the information gained during this design iteration to revise the problem specifications and/or explore neighboring or different regions of the design space 122, 130. Another option is to reconsider the motor's modeling assumptions, especially the design parameters and simulation settings, to ensure a more appropriate and representative model is selected. On the other hand, if a final design 110 is selected, this optimal traction electric motor design 110 is then passed to the engineering design team to check and validate for mechanical and manufacturing constraints.

Unlike previously known systems, the described optimization system 100 leverages the physical operation of traction electric motors to accelerate the development cycle. The first stage 300 and the second stage 400 in the optimization process 200 provide the computational advantage of systematically reducing the design space 122, 130 in consecutive passes using coarse and cheap models of traction motors. Known approaches for motor design directly couple the optimization procedure with the simulation environment (similar to the method described in the third stage 500) which significantly slows down the time required to find optimal designs of traction electric motors. Alternatively, less accurate 0D/1D or 2D models of traction electric motors are used to arrive at non-optimal designs with a room of result uncertainty. Therefore, exploiting physical representative models of traction electric motors in a data-driven methodology and a multi-stage process for design optimization with effective use of computational resources provides an improved system. The optimization system 100 significantly reduces the development time for designing traction electric motors, enables design space exploration for a wide parameter range, targets any set of requirements for different applications, and is agnostic to commercial software platforms for simulating traction electric motors.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Implementations of the subject matter and the functional operations described in this specification can be implemented in digital electronic circuitry, or in computer software, firmware, or hardware, including the structures disclosed in this specification and their structural equivalents, or in combinations of one or more of them. Moreover, subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The terms “data processing apparatus”, “computing device” and “computing processor” encompass all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

Similarly, while operations are depicted in the drawings in a particular order, this should not be understood as requiring that such operations be performed in the particular order shown or in sequential order, or that all illustrated operations be performed, to achieve desirable results. In certain circumstances, multi-tasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

A number of implementations have been described. Nevertheless, it will be understood that various modifications may be made without departing from the spirit and scope of the disclosure. Accordingly, other implementations are within the scope of the following claims.

What is claimed is:

1. A method for optimizing a design of an electric motor, the method comprising:
receiving, at a hardware computing device, user parameters from a user interface in communication with the hardware computing device, the user parameters including one or more traction electric motor design limitations;
determining, at the hardware computing device, a problem specification based on the user parameters; executing, at the hardware computing device, a global design search of traction electric motor designs based on the problem specification within a global design region;
identifying, at the hardware computing device, a high-performing design region being a portion of the global design region, wherein the high-performing design region includes multiple motor designs.

2. The method of claim 1, further comprising:
executing a higher resolution simulation of the high-performing design region;
determining an optimized design within the high-performing design region, wherein the optimized design is based on the user parameters, and desired operating points.

3. The method of claim 1, wherein the problem specification comprises parameters including desired target performance parameters, technical target parameters, desired operating points.

4. The method of claim 3, wherein prior to executing a global design search:
determining when design parameters similar to the parameters of the problem specification are stored in hardware memory;
when design parameters similar to the parameters of the problem specification are stored in hardware memory, determining the optimal motor design based on stored design parameters.

5. The method of claim 1, further comprising:
generating design samples based on the problem specification using Design of Experiment (DoE) method; and
computing simulation-based parametric models of traction electric motor, where each model is indicative of a different motor design.

6. The method of claim 5, further comprising:
performing first statistical analysis;
determining a statistical coefficient based on the first statistical analysis;
reducing a number of design parameters based on the statistical coefficient;
determining infeasible geometric motor designs from the computed simulation-based parametric models of the traction electric motor based using the reduced number of design parameters; and
for the feasible geometric motor designs, determining a representative reduced-order dq model of each design sample and determining control strategies of the design samples.

7. The method of claim 6, further comprising:
determining one or more Key Performance Indicators (KPIs) for each one of the geometric motor designs;
determining additional infeasible design samples based on the determined one or more KPIs; and
executing a second statistical analysis causing a reduction of the feasible geometric motor designs.

8. The method of claim 7, wherein the one or more KPIs includes: peak power, peak torque, maximum speed power, peak power density, peak torque density, peak current density, specific power, specific torque, airgap shear stress, power factor, constant-torque base speed, constant-power base speed, saliency ratio, per-unit magnet flux linkage, characteristic current, short-circuit current, DC winding resistive losses at different operating conditions, magnetic flux densities in different parts, volumes of different parts, masses of different parts, total material cost, material costs of different parts, material price per power, material price per torque, global warming potential, optimal current amplitudes, phase advance angles and stator phase voltages for different operating points, average torque, torque ripple, power factor, winding AC losses, core losses, magnet losses, efficiency, demagnetization risk, total harmonic distortion of the stator voltages and currents, phase RMS voltages and currents.

9. A method for optimizing a design of an electric motor, the method comprising:
during a first stage:
executing, at a hardware computing device, a global design search for a wide design space of traction electric motor designs;
removing, at the hardware computing device, non-optimal design regions using coarse and cheap simulation models;
during a second stage:
evaluating, at the hardware computing device, key performance indicators (KPIs) of the traction electric motor designs within a remaining design region;
identifying, at the hardware computing device, high-performing design regions of traction electric motor designs via statistical analysis based on the KPIs;
during a third stage:
determining, at the hardware computing device, a reduced design space for a local design region of traction electric motor designs to employ a higher resolution of design points using the same coarse simulation model or a finer simulation model; and
determining, at the hardware computing device, an optimized design of the traction electric motor from the reduced design space.

10. The method of claim 9, wherein the second stage further comprises:
determining infeasible design samples based on the determined one or more KPIs; and
executing statistical analysis causing a reduction of the feasible geometric motor designs.

11. The method of claim 9, further comprises, before the first stage:
receiving user parameters from a user interface in communication with the hardware computing device, the user parameters including one or more traction electric motor design limitations; and
determining, at the hardware computing device, a problem specification based on the user parameters.

12. The method of claim 11, further comprising:
before executing the first stage, determining when design parameters similar to the parameters of the problem specification are stored in hardware memory;
when design parameters similar to the parameters of the problem specification are stored in hardware memory, determining the optimal motor design based on a stored design.

13. The method of claim 11, wherein the problem specification comprises parameters including initial design parameters, desired target performance parameters, technical target parameters, and desired operating points.
